(19) United States
(12) Patent Application Publication
(10) Pub. No.: US 2012/0174888 A1
(43) Pub. Date: Jul. 12, 2012

(54) QUICK-RELEASE CAP WITH EJECTION RAMP

(75) Inventors: Manmeet S. Pannu, Sterling Heights, MI (US); Christopher Paul Nelander, West Bloomfield, MI (US); Thomas A. Spix, Rochester Hills, MI (US)

(73) Assignee: GM GLOBAL TECHNOLOGY OPERATIONS LLC, Detroit, MI (US)

(21) Appl. No.: 13/004,192

(22) Filed: Jan. 11, 2011

(51) Int. Cl. F02B 77/00; B65D 41/06

(52) U.S. Cl. 123/198 E; 220/300

(57) ABSTRACT

A quick-release cap is provided for closing the neck of a housing. The cap includes a core having a first end, a second end, and an exterior side wall between the first and second ends. The cap is configured to rotate between a cap-locked position securing the core within the neck and a cap-release position permitting removal of the core from the neck. A first groove is defined in the exterior side wall of the core and extends at least partially circumferentially around the core for receiving a first tab protruding from the neck. The first groove defines an ejection ramp for at least partially ejecting the first tab relative to the first groove when the cap moves from the cap-locked position to the cap-release position. The cap may be removed from the neck with the application of only a twisting force.

### TECHNICAL FIELD

The present invention relates generally to a cap for closing the neck of an opening or housing.

### BACKGROUND

A vehicle typically has an orifice, known as an oil filler opening, for an operator to replenish engine oil in the engine when the engine oil falls below a certain level. A removable cap is used to close the neck of the oil filler opening. Typically, the cap includes a sealing device to establish a sealed connection between the cap and the neck. An operator must apply axial or vertical force to break the sealed connection and remove the cap from the neck.

### SUMMARY

A cap is provided for closing the neck of a housing. The cap includes a core having a first end, a second end, and an exterior side wall extending between the first and second ends. The cap is configured to rotate between a cap-locked position securing the core within the neck and a cap-release position permitting removal of the core from the neck. A first groove is defined in the exterior side wall of the core and extends at least partially circumferentially around the core for receiving a first tab protruding from the neck. The first groove defines an ejection ramp configured to at least partially eject the first tab relative to the first groove when the core moves from the cap-locked position to the cap-release position. An operator may remove the cap from the neck by application of only a twisting force.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a cap in accordance with the present disclosure;

FIG. 2 is a partial schematic sectional view taken at lines 2-2 of the cap of FIG. 1 positioned in a housing;

FIG. 3 is a partial schematic sectional view taken at lines 3-3 of the cap of FIG. 1 positioned in the housing;

FIG. 4 is a schematic two-dimensional projection of a portion of the cap of FIG. 1; and

FIG. 5 is a schematic diagram of an oil fill port in an internal combustion engine of a vehicle. The cap of FIG. 1 may be used to cover the oil fill port.

### DETAILED DESCRIPTION

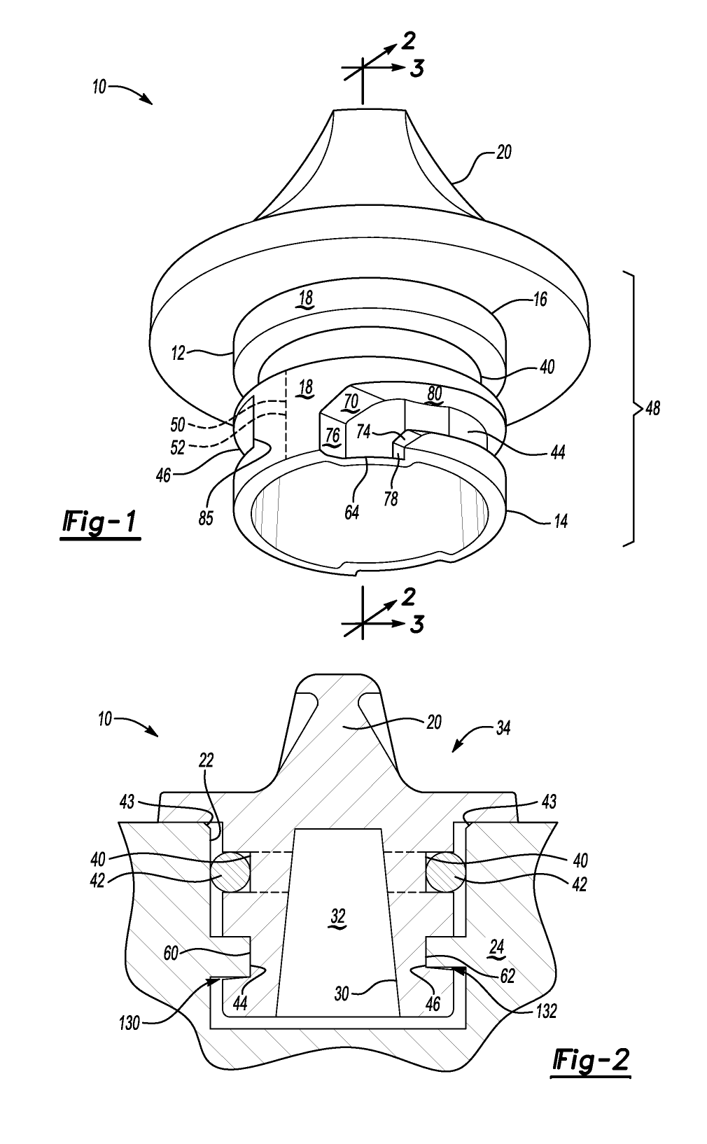

Referring to the Figures, wherein like reference numbers refer to the same or similar components throughout the several views, FIG. 1 is a schematic perspective view of a cap 10. The cap 10 includes a core 12 having a first end 14, a second end 16, and an exterior side wall 18 extending between the first and second ends 14, 16. The core 12 may be generally cylindrically shaped. The cap 10 may include a handle 20 operatively connected to the second end 16 of the core 12.

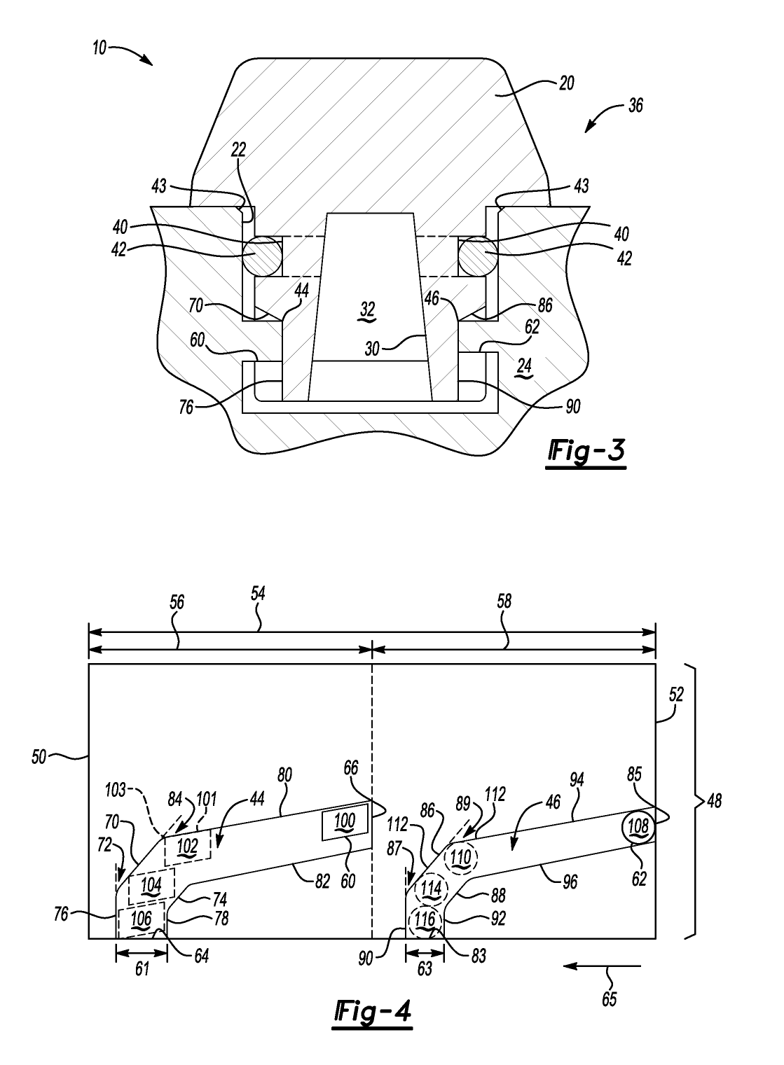

FIG. 2 is a schematic sectional view taken at lines 2-2 of the cap 10, shown in FIG. 1. FIG. 3 is a schematic sectional view taken at lines 3-3 of the cap 10, shown in FIG. 1. Referring to FIGS. 2-3, the cap 10 may be inserted into a neck 22 of a housing 24 in order to close or seal the neck 22. The core 12 may include inner walls 30 enclosing a hollow cavity 32. The core 12 does not have to be hollow and may be solid. The inner wall 30 may be angled, as shown in FIGS. 2-3, or formed in any shape.

The core 12 is configured to rotate between a cap-locked position 34 (shown in FIG. 2) securing or locking the cap 10 within the neck 22 and a cap-release position 36 (shown in FIG. 3) permitting removal of the cap 10 from the neck 22. Referring to FIGS. 1-3, a sealing groove 40 is defined in the exterior side wall 18 of the core 12 and extends circumferentially around the core 12. The sealing groove 40 is adapted to receive a sealing member 42 (shown in FIGS. 2-3). The sealing member 42 engages in the sealing groove 40 to form a sealed connection when the cap 10 is inserted in the neck 22. For example, the sealing member 42 may be an O-ring creating a radial seal in the neck 22. Optionally, a chamfer 43 (shown in FIGS. 2-3) is formed at the neck 22 to aid installation of the cap 10 into the neck 22. A person of ordinary skill in the art may select a chamfer angle appropriate for the specific application.

Referring to FIGS. 1-3, a first groove 44 is defined in the exterior side wall 18 of the core 12 and extends at least partially circumferentially around the core 12. Optionally, a second groove 46 may be formed symmetrically opposite the first groove 44, as shown in FIGS. 1-4. The second groove 46 is defined in the exterior side wall 18 of the core 12 and extends at least partially circumferentially around the core 12.

FIG. 4 is a schematic two-dimensional projection of a portion 48 (shown in FIG. 1) of the cap 10 showing the first and second grooves 44, 46. For illustration purposes, the first and second grooves 44, 46 in FIG. 4 are shown extending from a first line 50 to a second line 52. The first line 50 is coincident with the second line 52 in the exterior side wall 18 of the core 12, as shown in phantom in FIG. 1. The full circumference of the core 12 is represented by span 54, shown in FIG. 4. Each of the first and second groove 44, 46 extends over less than half the circumference of the cap 10. The first groove 44 extends over part of a first span 56. The second groove 46 extends over part a second span 58.

Referring to FIGS. 2-3, the first groove 44 is adapted to receive a first tab 60 protruding from the neck 22. The second groove 46 is adapted to receive a second tab 62 (shown in FIGS. 2-3) protruding from the neck 22. The first and second tabs 60, 62 may be formed on the inner surface of the neck 22 in the housing 24. Optionally, referring to FIG. 4, the width 61 of the first tab 60 may be selected to be different from the width 63 of the second tab 62. In this case, the first tab 60 cannot fit into the second groove 46. Having different widths 61, 63 is an error-proofing measure to ensure the cap 10 can only be fitted into the neck 22 in a particular configuration. Alternatively, the width 61 may be the same as the width 63. The first and second tabs 60, 62 may be shaped like a square, rectangle, circle, parallelogram or any other shape. The first and second tabs 60, 62 may have different shapes, as shown in FIG. 4. Alternatively, the first and second tabs 60, 62 may have the same shape.

Referring to FIG. 4, the first groove 44 defines an ejection ramp 70 having a substantially ramp-like shape. The ejection ramp 70 is characterized by a first ramp angle 72. The first ramp angle 72 may be selected by one of ordinary skill in the art for the application at hand. For example, the first ramp angle 72 may be optimized for the size and shape of the first tab 60 and the packaging space available. Referring to FIG. 4, the first groove 44 begins at an entry-exit end 64 and terminates at a locking end 66. The exit-entry end 64 is closer to the first end 14 of the core 12 than the locking end 66. The first groove 44 also includes a shoulder 80, surfaces 74, 82 and first and second edges 76, 78.

Referring to FIG. 4, the locking position 100 at the locking end 66 of the first groove 44 represents the position of the first tab 60 when the cap 10 is in the cap-locked position 34 (shown in FIG. 2). As the cap 10 is rotated in a cap-removal direction 65 (shown in FIG. 4), the first tab 60 slides from the locking position 100 to a first sliding position 102 (in phantom). As shown in FIG. 4, the first surface 101 of the first tab 60 slides along the shoulder 80 and the ejection ramp 70. The first tab 60 then slides to a second sliding position 104 (in phantom). It is the interaction of the first surface 101 and corner 103 of the first tab 60 pushing along the ejection ramp 70 that ejects the first tab 60 relative to the first groove 44. In doing so, the ejection ramp 70 pushes or ‘pops’ the sealing member 42 out of the neck 22 and the cap 10 out of the neck 22. When the first tab 60 reaches an entry-exit position 106 (in phantom) at the entry-exit end 64, the cap 10 may be removed from the neck 22.

Typically, an operator must apply axial or vertical force to remove a cap having a sealed connection. The ejection ramp 70 enables an operator to remove the cap 10 from the neck 22 by application of only a rotating or twisting force. Optionally, the junction between the ejection ramp 70 and the first edge 76 may be smoothed to prevent a sharp corner and provide a smooth transition for the first tab 60. The junctions between the ejection ramp 70 and the surface 80 as well as between the second edge 78 and the surface 74 may also be smoothed for the same reason.

The first and second edges 76, 78 are connected to the entry-exit end 64 and oriented substantially perpendicularly to the entry-exit end 64. The shoulder 80 and surface 82 are connected to the locking end 66 and may be substantially parallel to each other. The first groove 44 defines a groove angle 84 between the ejection ramp 70 and the shoulder 80, which may be optimized for various parameters. The surfaces 74 and 82 are useful in inserting or installing the cap 10 in the neck 22.

### Second Groove

Where the cap 10 includes the optional second groove 46, the second groove 46 defines an ejection ramp 86 (separate from ejection ramp 70 of the first groove 44) having a substantially ramp-like shape, as shown in FIG. 4. The ejection ramp 86 is characterized by a ramp angle 87, which may be optimized for the size and shape of the second tab 60 and other parameters. Referring to FIG. 4, the second groove 46 begins at an entry-exit end 83 and terminates at a locking end 85. The exit-entry end 83 is closer to the first end 14 of the core 12 than the locking end 85. The second groove 46 also includes a shoulder 94, surfaces 88, 96 and first and second edges 90, 92.

Referring to FIG. 4, the second tab 62 is at locking position 108 at the locking end 66 of the first groove 44, when the cap 10 is in the cap-locked position 34. As the cap 10 is rotated in the cap-removal direction 65, the second tab 62 slides from the locking position 108 to a first sliding position 110 (in phantom). As shown in FIG. 4, the first surface 112 of the second tab 62 slides along the shoulder 94 and the ejection ramp 86. The second tab 62 then slides to a second sliding position 114 (in phantom). It is the interaction of the first surface 112 of the second tab 62 pushing along the ejection ramp 86 that ejects the second tab 62 relative to the second groove 46. In doing so, the ejection ramp 86 pushes or ‘pops’ the sealing member 42 out of the neck 22 and the cap 10 out of the neck 22. When the second tab 62 reaches an entry-exit position 116 (in phantom) at the entry-exit end 83, the cap 10 may be removed from the neck 22.

Optionally, the locking and exit-entry ends 83, 85 of the second groove 46 are a different size from the locking and exit-entry ends 64, 66 of the first groove 44. Referring to FIG. 4, the first and second edges 90, 92 are connected to the exit-entry end 83 and oriented substantially perpendicularly to the exit-entry end 83. The shoulder 94 and surface 96 are connected to the locking end 85 and may be substantially parallel to each other. The second groove 46 defines a groove angle 89 between the ejection ramp 86 and the shoulder 94, which may be optimized for various parameters.

Referring to FIG. 2, a draft angle 130 may be incorporated into each of the six parts of the first groove 44 (ejection ramp 70, shoulder 80, surfaces 74, 82 and first and second edges 76, 78). Similarly, a draft angle 132 (shown in FIG. 2) may be incorporated into each of the six parts of the second groove 46 (ejection ramp 86, shoulder 94, surfaces 88, 96 and first and second edges 90, 92). The cap 10 may be made from an injection-molded plastic. Having draft angles 98 and 99 allow the cap 10 to be released from a mold (not shown) without distortion or damage. A third groove (not shown) may also be added.

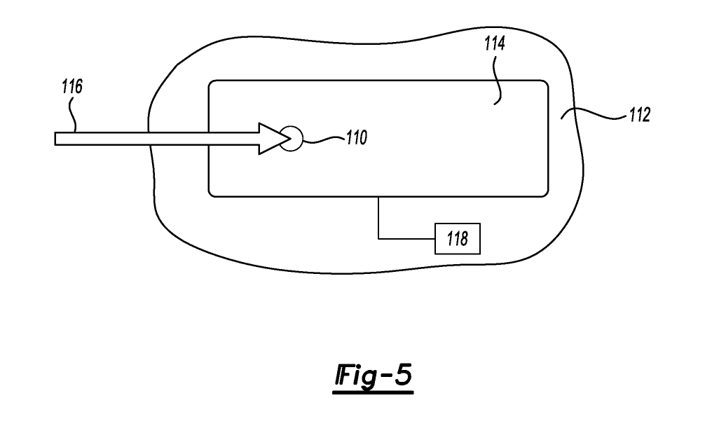

The cap 10 (shown in FIGS. 1-3) may be used to close or cover an oil fill port of an internal combustion engine. FIG. 5 is a schematic diagram of an oil fill port 110 in an internal combustion engine 112 of a vehicle. The oil fill port 110 may be housed in a crankcase cover 114 of the engine 112. Oil 116 that is poured into the oil fill port 110 is used to lubricate components of the engine 112. The oil 116 may be stored in a storage device 118 such as an oil pan. The cap 10 may be used for non-vehicle applications as well.

While the best modes for carrying out the invention have been described in detail, those familiar with the art to which this invention relates will recognize various alternative designs and embodiments for practicing the invention within the scope of the appended claims.

1. A cap engageable with a neck of a housing having a first tab protruding from the neck, the cap comprising:
a core having a first end, a second end, and an exterior side wall extending between the first end and the second end;
wherein the cap is configured to rotate between a cap-locked position securing the core within the neck and a cap-release position permitting removal of the core from the neck;
a first groove defined in the exterior side wall of the core and extending at least partially circumferentially around the core for receiving the first tab protruding from the neck; and
wherein the first groove defines an ejection ramp configured to at least partially eject the first tab relative to the first groove when the cap moves from the cap-locked position to the cap-release position.

2. The cap of claim 1, further comprising:
a sealing groove defined in the exterior side wall of the core and extending circumferentially around the core for receiving a sealing member; and
wherein the cap can be removed from the neck without application of an axial force.

3. The cap of claim 1, further comprising a handle operatively connected to the second end of the core.

4. The cap of claim 1, wherein the first groove begins at an entry-exit end and terminates at a locking end, the entry-exit end being closer to the first end of the core than the locking end.

5. The cap of claim 4, further comprising first and second edges connected to and oriented substantially perpendicularly to the entry-exit end.

6. The cap of claim 5, wherein a second tab protrudes from the neck and further comprising:
a second groove defined by the exterior side wall of the core and extending at least partially circumferentially around the core for receiving the second tab protruding from the neck; and
a separate ejection ramp defined by the second groove and configured to at least partially eject the second tab relative to the second groove when the core moves from the cap-locked position to the cap-release position.

7. The cap of claim 6, wherein the second groove begins at a separate entry-exit end and terminates at a separate locking end, the separate entry-exit end being closer to the first end of the core than the separate locking end.

8. The cap of claim 7, wherein the entry-exit end of the first groove is a different size from the separate entry-exit end of the second groove.

9. The cap of claim 8, wherein the locking end of the first groove is a different size from the separate locking end of the second groove.

10. A cap engageable with a neck of a housing having first and second tabs protruding from the neck, the cap comprising:
a generally cylindrical-shaped core having a first end, a second end, and an exterior side wall extending between the first and second ends;
wherein the core is configured to rotate between a cap-locked position securing the core within the neck and a cap-release position permitting removal of the core from the neck;
a sealing groove defined in the exterior side wall of the core and extending circumferentially around the core for receiving a sealing member;
a first groove defined in the exterior side wall of the core and extending at least partially circumferentially around the core for receiving the first tab protruding from the neck;
wherein the first groove defines an ejection ramp configured to at least partially eject the first tab relative to the first groove when the core moves from the cap-locked position to the cap-release position;
a second groove defined by the exterior side wall of the core and extending at least partially circumferentially around the core for receiving the second tab protruding from the neck;
wherein the second groove defines another ejection ramp configured to at least partially eject the second tab relative to the second groove when the core moves from the cap-locked position to the cap-release position; and
wherein the first tab is a different size from the second tab.

11. The cap of claim 10, in combination with the housing, wherein the neck is an oil fill port of an internal combustion engine.

12. The cap of claim 11, in combination with the housing, wherein the housing is a crankcase cover of the engine.

13. An internal combustion engine comprising:
an oil fill port having a first tab protruding from the oil fill port;
a cap insertable in the oil fill port;
the cap defining a core having a first end, a second end, and an exterior side wall extending between the first and second ends;
wherein the cap is configured to rotate between a cap-locked position securing the core within the oil fill port and a cap-release position permitting removal of the core from the oil fill port;
a sealing groove defined in the exterior side wall of the core and extending circumferentially around the core for receiving a sealing member;
a first groove defined in the exterior side wall of the core and extending at least partially circumferentially around the core for receiving the first tab protruding from the oil fill port;
an ejection ramp defined by the first groove having a substantially ramp-like shape for at least partially ejecting the first tab relative to the first groove when the core rotates from the cap-locked position to the cap-release position;
a second groove defined by the exterior side wall of the core and extending at least partially circumferentially around the core for receiving the second tab protruding from the oil fill port;
wherein the second groove defines another ejection ramp configured to at least partially eject the second tab relative to the second groove when the core moves from the cap-locked position to the cap-release position; and
wherein the cap can be removed from the oil fill port by application of only a twisting force.

14. The engine of claim 13, wherein the first tab is a different size from the second tab.

15. The engine of claim 13, further comprising an oil storage device operatively connected to the oil fill port.
